(19) United States
(12) Patent Application Publication
(10) Pub. No.: US 2010/0329107 A1
(43) Pub. Date: Dec. 30, 2010

(54) METHOD OF ALLOCATING UPLINK RESOURCE REGION

(76) Inventors: Young Soo Yuk, Gyeonggi-do (KR); Jeong Ki Kim, Gyeonggi-do (KR); Ki Seon Ryu, Gyeonggi-do (KR)

Correspondence Address: BIRCH STEWART KOLASCH & BIRCH, PO BOX 747, FALLS CHURCH, VA, 22040-0747, US

(21) Appl. No.: 12/867,865

(22) PCT Filed: Feb. 27, 2009
(86) PCT No.: PCT/KR2009/000959

§ 371 Date: Aug. 16, 2010

Related U.S. Application Data
(60) Provisional application No. 61/032,440, filed on Feb. 29, 2008.

(30) Foreign Application Priority Data
May 23, 2008 (KR) 10-2008-0048227

(51) Int. Cl. H04J 11/00; H04W 72/00

(52) U.S. Cl. 370/208; 370/329

(57) ABSTRACT

A method for a base station to allocate an uplink resource using an uplink map in a wireless access system is disclosed. The present invention includes the steps of receiving a system information delivery message including subframe configuration information, receiving a map message including information on an allocation location of an uplink resource region, and calculating a time of allocating the uplink resource region using the subframe configuration information and the information on the allocation location of the uplink resource region.

This application claims the benefit of the Korean Patent Application No. 10-2008-0048227, filed on May 23, 2008, which is hereby incorporated by reference as if fully set forth herein.

This application also claims the benefit of U.S. Provisional Application Ser. No. 61/032,440, filed on Feb. 29, 2008, the contents of which are hereby incorporated by reference in their entirety.

### BACKGROUND OF THE INVENTION

1. Field of the Invention

The present invention relates to a wireless access system, and more particularly, to a method of allocating an uplink resource in a base station using an uplink map.

2. Discussion of the Related Art

First of all, a general frame structure used for a wireless access system is explained in the following description.

FIG. 1 is a diagram for a frame structure used by a broadband wireless access system (e.g., IEEE 802.16).

Referring to FIG. 1, a horizontal axis of a frame corresponds to a time unit and indicates an OFDMA (orthogonal frequency division multiple access) symbol. A vertical axis of the frame corresponds to a frequency unit and indicates a logical number of a subchannel.

In FIG. 1, one frame is divided into a data sequence channel for a predetermined time period according to a physical property. In particular, one frame is constructed with one downlink subframe and one uplink subframe. The downlink subframe ad the uplink subframe are divided by a transmit transition gap (TTG). And, frames are divided by a receive transition gap (RTG).

In this case, the downlink subframe is able to include one preamble, a frame control header (FCH), a downlink map (DL-MAP), an uplink map (UL-MAP) and at least one data burst. The uplink subframe is able to include at least one uplink data burst and a ranging subchannel.

In FIG. 1, a preamble is a specific sequence data located at a first symbol of each frame and is used for a terminal to match synchronization with a base station or to estimate a channel. A frame control header (FCH) is used to provide channel allocation information related to DL-MAP and information on a channel code. The DL-MAP/UL-MAP is a MAC (media access control) message used to inform of channel resource allocation in downlink/uplink. And, a data burst indicates a unit of data transmitted to a terminal/base station from the base station/terminal.

A downlink channel descriptor (DCD) usable for FIG. 1 indicates a MAC message to indicate a physical property of a downlink channel. And, an uplink channel descriptor (UCD) indicates a MAC message to indicate a physical property of an uplink channel.

In case of downlink, referring to FIG. 1, a terminal matches synchronization with a base station by detecting a preamble transmitted from the base station. Subsequently, it is able to decode a downlink map using information obtained from a frame control header (FCH).

The base station is able to transmit scheduling information for uplink or downlink resource allocation to the terminal each frame (e.g., 5 ms) using a downlink map (DL-MAP) message or an uplink map (UL-MAP) message.

Since the DL-MAP/UL-MAP message described with reference to FIG. 1 is transmitted at a modulation and coding scheme (MCS) level enabling all terminals to receive the corresponding message, an unnecessary map message overhead may be generated. For instance, since terminals around a base station are in good channel status, they use a high MCS level (e.g., QPSK 1/2) to encode/decode messages. Yet, the base station will transmit a map message by encoding the map message at a low MCS level (e.g., QPSK 1/12) for terminals located on a cell boundary. Therefore, as each terminal always receives the message encoded at the same MCS level irrespective of a channel status, an unnecessary map message overhead may be generated.

Table 1 shows an example of an uplink MAP (UL-MAP) message format that is generally used.

TABLE 1

| Syntax | | Size | Contents |
|---|---|---|---|
| UL-MAP_Message_Format( ){ | | — | — |
| | Management Message Type = 3 | 8 | — |
| | Reserved | 8 | Shall be set to zero |
| | UCD Count | 8 | — |
| | Allocation Start Time | 32 | — |
| | Begin PHY-specific section{ | — | see applicable |

| | | PHY subclause |
|---|---|---|
| if(Wireless MAN-OFDMA){ | — | — |

| | | |
|---|---|---|
| No. OFDMA symbols | 8 | Number of OFDMA |

| | | symbols in the UL |
|---|---|---|
| | | subframe |
| } | — | — |
| for(i=1; i<=n; i++){ | — | For each UL-MAP |

| | | element 1 to n. |
|---|---|---|
| UL-MAP_IE( ) | variable | See corresponding |

| | | PHY specification |
|---|---|---|
| } | — | — |

| | | |
|---|---|---|
| } | — | — |
| if !(byte boundary){ | — | — |

| | | |
|---|---|---|
| Padding Nibble | 4 | Padding to reach |

| | | byte boundary |
|---|---|---|
| } | — | — |

| | | |
|---|---|---|
| } | — | — |

Referring to Table 1, a management message type is set to 3 to indicate an uplink map (UL-MAP) message. An uplink channel descriptor (UCD) indicates uplink channel information (e.g., uplink burst profiled). A UCD count field indicates a value of a configuration change count of the uplink channel descriptor. An allocation start time field indicates an effective start time of uplink allocation defined by the uplink map message and has a physical layer-specific (PHY-specific) unit. Moreover, an OFDM symbol number field (No. OFDMA symbols) indicates the number of OFDMA symbols in an uplink subframe.

It is able to represent the allocation start time of the UL-MAP as a PS (physical slot) unit from a start of a DL subframe in which the UL-MAP message occurs. A minimum value of an allocation start time parameter may be a time indicated by T_{proc} defined by a global variable. The T_{proc} is 200 us in SC, 1 ms in OFDM, or T_{f} (frame duration code: 5 ms in WiMAX profile). In particular, the uplink allocation in TL-MAP of an OFDMA system has at least 1-frame duration.

The PS can be calculated according to Formula 1 in the OFDMA system.

$$PS = \frac{4}{Fs} \qquad [ Formula 1 ]$$

In Formula 1, ‘Fs’ indicates a sampling frequency of Hertz (Hz) unit. In the OFDMA system, the Fs can be calculated according to Formula 2.

$$PS = \frac{4}{Fs} \qquad [ Formula 2 ]$$

In Formula 2, ‘n’ is a sampling factor and can be represented as n=8/8 for a channel bandwidth that is a multiple of 1.75 MHz. For a channel bandwidth as a multiple of 1.25, 1.5 or 2 MHz, n is set to 28/25 (i.e., n=28/25). Yet, for a different channel bandwidth, n is set to 8/7 (i.e., n=8/7).

For example, an OFDMA system having a bandwidth (BW) of 10 MHz is explained as follows.

First of all, referring to Formula 1 and Formula 2, Fs is 11200000 Hz (11.2 MHz) and PS is 0.35714857 us. Hence, the number of PSs per frame having a size of 5 ms amounts to 14,000.

Thus, in the OFDMA system having the BW of 20 MHz, Fs is 22400000 Hz (22.4 MHz) and PS is 0.17857. Namely, the number of PSs per frame having a size of 5 ms amounts to 28,000. In this case, the number of PSs included in two frames having a length of 20 ms is 112,000. And, the number of PSs included in two frames having a length of 20 ms with a BW of 20 MHz will becomes 224,000. This value does not exceed a maximum time relevance to UL MAP.

Referring to Table 1, in a wireless MAN system, a size of an allocation start time field included in a UL-MAP message field amounts to 32 bits. Hence, the allocation start time field can represent 0˜4292967295.

However, in the OFDMA system, if a 32-bit allocation start time field is included in a UL-MAP every frame, resources may be wasted.

Moreover, when a subframe structure (or, a mini-frame structure) for reducing a decoding process time of an uplink map is applied, if a 32-bit allocation start time is included in each uplink sub-map, resources may be further wasted.

### SUMMARY OF THE INVENTION

Accordingly, the present invention is directed to a method of allocating an uplink resource in a base station using an uplink map that substantially obviates one or more problems due to limitations and disadvantages of the related art.

An object of the present invention is to provide a method of setting a precise start time for applying resource allocation information included in an uplink map.

Another object of the present invention is to provide a method of accurately allocating an uplink radio resource in a base station in case of using a subframe structure.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

The present invention relates to a method for a base station to allocate an uplink resource using an uplink map.

To achieve these objects and other advantages and in accordance with the purpose of the invention, as embodied and broadly described herein, a method of allocating a resource region according to the present invention includes the steps of receiving a system information delivery message including subframe configuration information, receiving a map message including information on an allocation location of an uplink resource region, and calculating a time of allocating the uplink resource region using the subframe configuration information and the information on the allocation location of the uplink resource region.

Preferably, the map message includes an uplink sub-map message and the information on the allocation location of the uplink resource region indicates that the resource region is allocated to a prescribed uplink subframe in specific order among uplink subframes.

Preferably, the map message includes a super map message and the information on the allocation location of the uplink resource region indicates that the resource region is allocated to a prescribed uplink subframe in specific order among uplink subframes.

Preferably, the map message includes an uplink sub-map message and the information on the allocation location of the uplink resource region indicates that an uplink resource region is allocated after a prescribed subframe in specific order from a next subframe to a subframe in which the uplink sub-map is received.

Preferably, the map message includes a super map message and the information on the allocation location of the uplink resource region indicates that an uplink resource region is allocated after a prescribed subframe in specific order from a next subframe to a subframe in which the uplink sub-map is received.

Preferably, the map message includes an uplink sub-map message and the information on the allocation location of the uplink resource region indicates that an uplink resource region is allocated after a prescribed symbol from a subframe in which the uplink sub-map is received.

Preferably, the map message includes a super map message and the information on the allocation location of the uplink resource region indicates that an uplink resource region is allocated after a prescribed symbol from a subframe in which the uplink sub-map is received.

Preferably, the further includes the step of if the allocation location of the uplink resource region is changed, receiving an uplink sub-map including changed location information of the uplink resource region.

Preferably, the subframe configuration information includes at least one selected from the group consisting of information on a ratio of uplink to downlink (DL/UL ratio), a switching time between the uplink and the downlink, information on a TTG length, a TTG number, an RTG length and an RTG number.

In another aspect of the present invention, a method of allocating a resource region includes the steps of receiving a system information delivery message including subframe configuration information and information on an allocation location of an uplink resource region and calculating a time of allocating the uplink resource region using the subframe configuration information and the information on the allocation location of the uplink resource region.

In another aspect of the present invention, a method of allocating a resource region includes the steps of transmitting a system information delivery message including subframe configuration information, transmitting a map message including information on an allocation location of an uplink resource region, and receiving an uplink signal through the uplink resource region calculated according to the subframe configuration information and the information on the allocation location of the uplink resource region.

In a further aspect of the present invention, a method of allocating a resource region includes the steps of transmitting a system information delivery message including subframe configuration information and information on an allocation location of an uplink resource region and receiving an uplink signal through the uplink resource region calculated using the subframe configuration information and the information on the allocation location of the uplink resource region.

Accordingly, the present invention provides the following effects and/or advantages.

First of all, in a frame structure supporting a subframe, the present invention provides a method of enabling a base station to deliver information on an allocation start time of an uplink resource by subframe unit or symbol unit to terminals, thereby reducing waste of resources.

Secondly, in a frame structure supporting a subframe, the present invention provides a method of enabling a terminal to calculate a precise uplink resource allocation start time using information received from a base station, thereby reducing waste of resources.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for a frame structure used by a broadband wireless access system (e.g., IEEE 802.16);

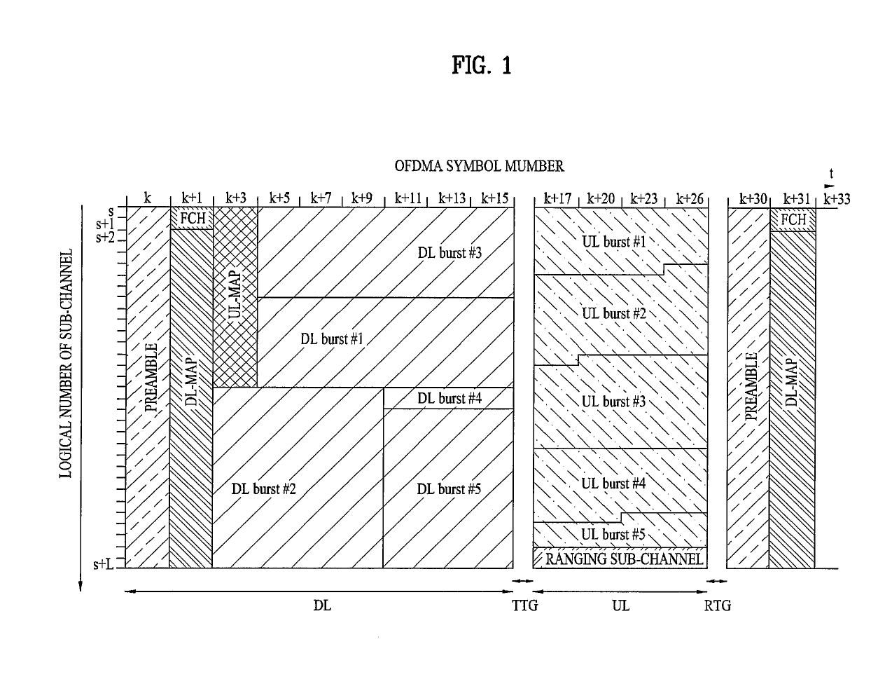

FIG. 2 is a diagram for a method of allocating a resource using an uplink map in a wireless metropolitan area network-orthogonal frequency division multiple access (MAN-OFDMA) system and a method of announcing an allocation start time of an uplink resource;

FIG. 3 is a diagram of the minimum time relevance to UL-MAP and DL-MAP in a wireless MAN TDD (time division duplexing) system;

FIG. 4 is a diagram of the maximum time relevance to UL-MAP and DL-MAP in a wireless MAN TDD (time division duplexing) system;

FIG. 5 is a diagram for an example of a subframe structure applicable to embodiments of the present invention;

FIG. 6 is a diagram for an example of a ratio of a downlink subframe to an uplink subframe in a subframe structure applicable to embodiments of the present invention;

FIG. 7 is a diagram for a method of announcing an uplink allocation time using an uplink sub-map (UL sub-MAP) according to one embodiment of the present invention;

FIG. 8 is a diagram for one of methods of announcing an uplink allocation time using an uplink sub-map (UL sub-MAP) according to one embodiment of the present invention;

FIG. 9 is a diagram for a method of announcing an uplink allocation time using an uplink sub-map (UL sub-MAP) according to another embodiment of the present invention;

FIG. 10 is a diagram for a method of announcing an uplink allocation time using a super map according to another embodiment of the present invention;

FIG. 11 is a diagram for a different method of announcing an uplink allocation time using a super map according to another embodiment of the present invention;

FIG. 12 is a diagram for a method of announcing an uplink allocation time using a system information delivery message according to another embodiment of the present invention;

FIG. 13 is a diagram for a method of announcing an uplink allocation time by a symbol unit according to another embodiment of the present invention;

FIG. 14 is a diagram for a method of announcing an uplink allocation time by a symbol unit using a super map according to another embodiment of the present invention; and

FIG. 15 is a diagram for a method of announcing an uplink allocation time by a symbol unit using a system information delivery message according to a further embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention relates to a wireless access system, and more particularly, to a method of allocating an uplink resource in a base station using an uplink map. And, the present invention also relates to a method of setting an allocation start time of uplink allocation information included in an uplink map.

First of all, the following embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment.

In this disclosure, embodiments of the present invention are described centering on the data transmission/reception relations between a base station and a terminal. In this case, the base station is meaningful as a terminal node of a network which directly performs communication with the terminal. In this disclosure, a specific operation explained as performed by a base station can be performed by an upper node of the base station in some cases.

In particular, in a network constructed with a plurality of network nodes including a base station, it is apparent that various operations performed for communication with a terminal can be performed by a base station or other networks except the base station. In this case, ‘base station’ can be replaced by such a terminology as a fixed station, a Node B, an eNode B (eNB), an access point and the like. And, ‘terminal’ can be replaced by such a terminology as a user equipment (UE), a mobile station (MS), a mobile subscriber station (MSS)′ and the like.

Embodiments of the present invention can be implemented using various means. For instance, embodiments of the present invention can be implemented using hardware, firmware, software and/or any combinations thereof.

In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

In the following description, specific terminologies are provided to help the understanding of the present invention. And, the use of the specific terminology can be modified into another form within the scope of the technical idea of the present invention.

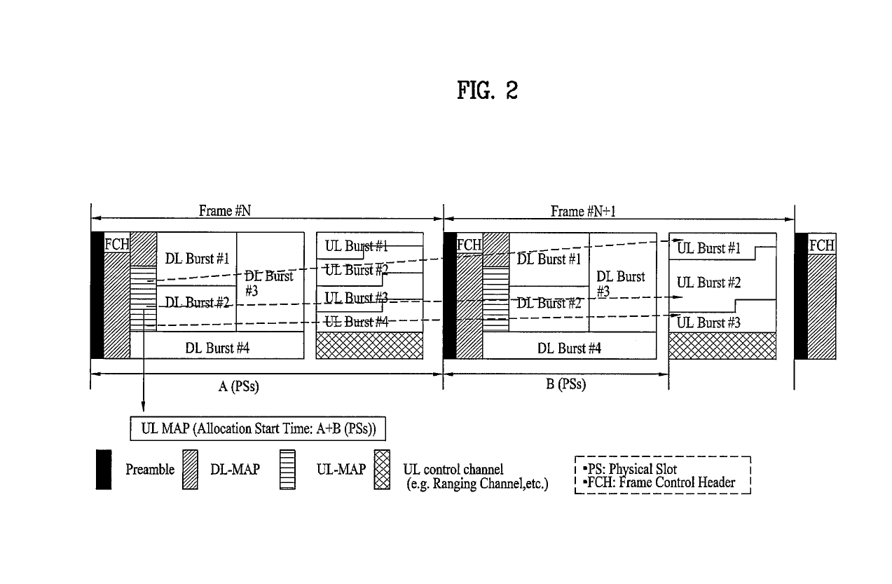

FIG. 2 is a diagram for a method of allocating a resource using an uplink map in a wireless metropolitan area network-orthogonal frequency division multiple access (MAN-OFDMA) system and a method of announcing an allocation start time of an uplink resource.

Referring to FIG. 2, one frame is constructed with physical slots (PS) amounting to the number of A. And, a downlink subframe is constructed with physical slots (PS) amounting to the number of B (DL subframe length+TTG).

UL-MAP contains information on uplink resource allocation. In this case, a size of an allocation start time field contained in the UL-MAP message amounts to 32 bits (refer to Table 1) and is set to (A+B). A unit of an allocation start time is PSs.

In particular, an uplink resource allocation instructed by UL-MAP of an N^{th} frame shown in FIG. 2 is performed after (A+B) PSs from a start of the N^{th} frame. This indicates a start point of an uplink subframe of an (N+1)^{th} frame. Therefore, in the UL-MAP of the N^{th} frame, allocation information of uplink bursts (e.g., UL Burst #1, UL Burst #2, UL Burst #3) of the (N+1)^{th} frame.

Timing information of DL-MAP and timing information of UL-MAP are relative to each other. For instance, the timing information of the DL-MAP starts from a start (if a preamble exists, it is included.) of a first symbol of a frame at which the DL-MAP message is transmitted. And, the timing information of the UL-MAP starts from a sum of a value of a start (if a preamble exists, it is included.) of a first symbol of a frame, at which the UL-MAP message is transmitted, and an allocation start time.

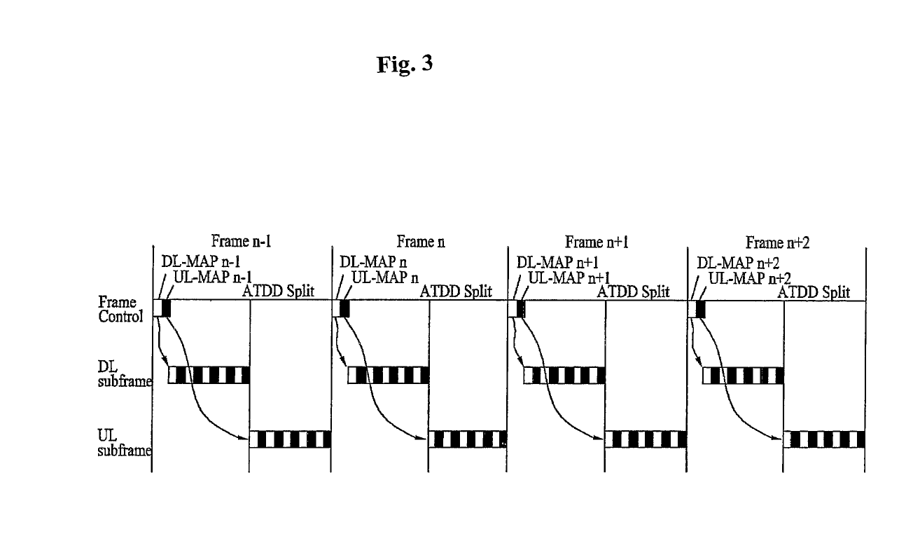

FIG. 3 is a diagram of the minimum time relevance to UL-MAP and DL-MAP in a wireless MAN TDD (time division duplexing) system.

Referring to FIG. 3, the minimum time relevance to an uplink map indicates a start of a first symbol of an uplink subframe of a frame in which a message is included.

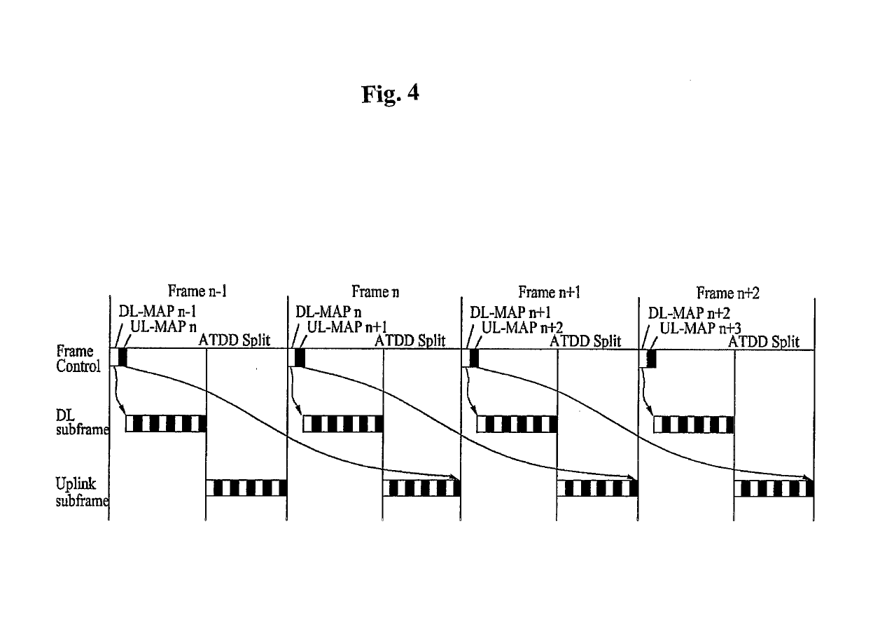

FIG. 4 is a diagram of the maximum time relevance to UL-MAP and DL-MAP in a wireless MAN TDD (time division duplexing) system.

Referring to FIG. 4, the maximum time relevance to an uplink map indicates a start of a last symbol of an uplink subframe of a next frame to a frame in which a message is included.

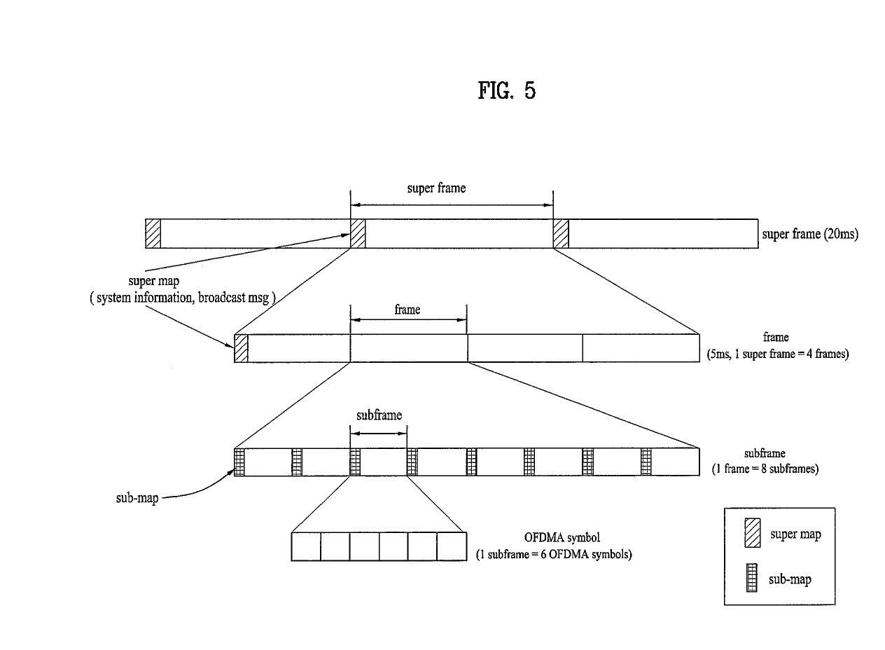

FIG. 5 is a diagram for an example of a subframe structure applicable to embodiments of the present invention.

Referring to FIG. 5, one super frame includes at least one frame. And, one frame is able to include at least one subframe. Moreover, one subframe is able to include at least one PFDMA symbol.

The lengths and numbers of super frames, frames and symbols are adjustable according to a user's request, a system configuration, etc. In embodiments of the present invention, a terminology ‘subframe’ is used. In this case, the ‘subframe’ means every lower frame structure generated by splitting one frame with a prescribed length.

In FIG. 5, assume that a length of one super frame and a length of one frame are 20 ms and 5 ms, respectively. In particular, one super frame can be constructed with four frames. One frame can be constructed with eight subframes. Moreover, one of the subframes can be constructed with six OFDMA symbols. It is understood that, the above-detailed values are variable according to a channel environment.

In FIG. 5, a super frame map exists in a head part of each super frame. The super frame map is able to have a structure (e.g., a message form, a channel form) for delivering mandatory system information for configuring a super frame or a subframe. A base station is able to transmit a super frame map to terminals each super frame period. In this case, the super frame map can be called ‘super map’ or ‘super frame header’.

In the embodiments of the present invention, the super frame map shall be named a super map for clarity. And, a structure for delivering system information not contained in the super map shall be named a system information delivery message. In this case, it is able to transmit the system information delivery message with a period (e.g., 0.5˜1.0 second) longer than a super frame period (20 ms).

A subframe map exists at a head part of a subframe. The subframe map is a control structure for transmitting subframe configuration information and scheduling information (e.g., resource allocation information) to terminals and can be configured in a message or channel form. In this disclosure, the subframe map shall be named a sub-map. And, a downlink sub-map (DL-Sub MAP) and an uplink sub-map (UL-Sub MAP) are conceptionally included in the sub-map.

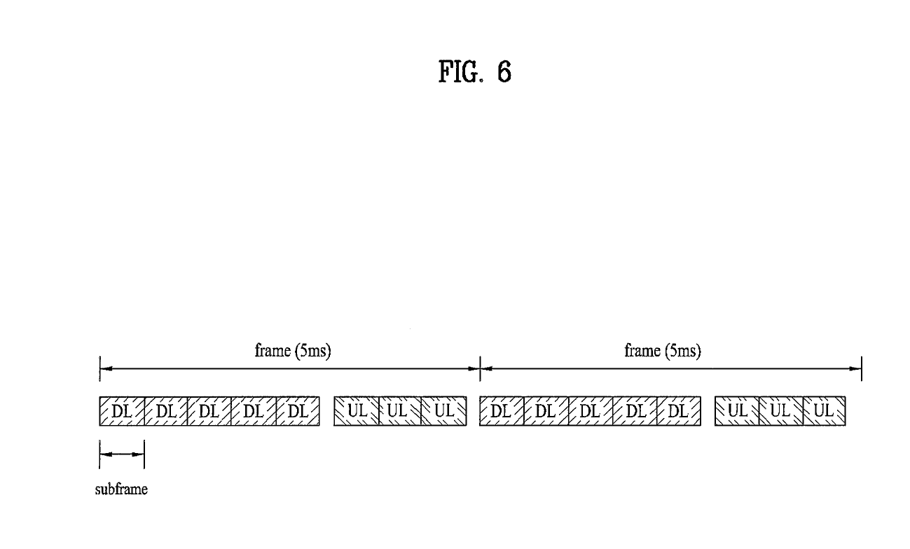

FIG. 6 is a diagram for an example of a ratio of a downlink subframe to an uplink subframe in a subframe structure applicable to embodiments of the present invention.

First of all, the example shown in FIG. 6 is applicable to a TDD (time division duplexing) system. FIG. 6 illustrates a case that ratios of the downlink subframe number to the uplink subframe number are different from each other. For instance, it is able to set a ratio of downlink subframes and uplink subframes to 5:3. In particular, in case that one frame is constructed with eight subframes, it can include five downlink subframes and three uplink subframes.

In the following description, a method of announcing an uplink resource allocation time, which is applicable to the subframe structure described with reference to FIG. 5 and FIG. 6, is explained.

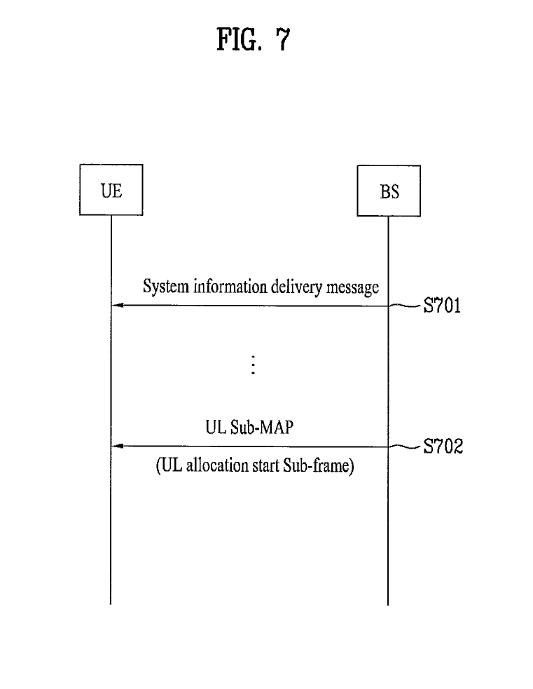

FIG. 7 is a diagram for a method of announcing an uplink allocation time using an uplink sub-map (UL Sub-MAP) according to one embodiment of the present invention.

Referring to FIG. 7, a base station is able to deliver system information to a terminal using a system information delivery message [S701].

The terminal is able to obtain a configuration ratio of downlink subframes to uplink subframes (DL/UL ratio), a switching point between DL subframe and UL subframe (DL/UL switching point), TTG and RTG from the system information. From the obtained values, the terminal is also aware that specific information is located at a specific point (by PS unit) of a subframe in specific order.

The base station is able to deliver scheduling information of a subframe to the terminal using a sub-map. According to one embodiment of the present invention, the base station is able to announce information on an uplink start subframe (allocation start time) using an uplink sub-map (UL Sub-MAP).

Table 2 shows an example of an information (UL allocation start subframe) structure included in an uplink sub-map by a base station to deliver information on an allocation start time of an uplink resource.

| Name | Size | Values |
|---|---|---|
| UL allocation | 2 bits | Case that DL/UL ratio is set to 4:4 in total |
| start sub-frame | | 8-subframe structure: |
| | | 0b00: This indicates a first uplink frame in |
| | | UL Sub-MAP transmitted frame. |
| | | 0b01: This indicates a second uplink frame in |
| | | UL Sub-MAP transmitted frame. |
| | | 0b10: This indicates a third uplink frame in |
| | | UL Sub-MAP transmitted frame. |
| | | 0b11: This indicates a fourth uplink frame in |
| | | UL Sub-MAP transmitted frame. |
| | | Case that DL/UL ratio is set to 5:3 |
| | | 0b00: This indicates a first uplink frame in |
| | | UL Sub-MAP transmitted frame. |
| | | 0b01: This indicates a second uplink frame in |
| | | UL Sub-MAP transmitted frame. |
| | | 0b10: This indicates a third uplink frame in |
| | | UL Sub-MAP transmitted frame. |
| | | 0b11: reserved |
| | | Case that DL/UL ratio is set to 6:2 |
| | | 0b00: This indicates a first uplink frame in |
| | | UL Sub-MAP transmitted frame. |
| | | 0b01: This indicates a second uplink frame in |
| | | UL Sub-MAP transmitted frame. |
| | | 0b10~0b11: reserved |

UL allocation start subframe indicates that resource allocation information indicated by a current uplink sub-map is mapped to an uplink subframe in prescribed order. And, a range of a value of the UL allocation start subframe varies according to the DL/UL ratio.

If the terminal receives the uplink sub-map, the terminal is aware that scheduling information indicated by the uplink sub-map starts from which uplink subframe using the UL allocation start subframe.

The base station is able to transmit the uplink sub-map by having UL allocation start subframe information included in the uplink sub-map each time it transmits the uplink sub-map. In Table 2, the configuration ratio of DL to UL (DL/UL ratio) is limited to 6:2, 5:3 or 4:4. Namely, Table 2 shows a case that the number of uplink subframes is limited to maximum 4. And, it is understood that different ratios are applicable according to system configurations or user requests.

The terminal is able to calculate an allocation time of uplink subframe by Formula 3 with reference to the parameters shown in Table 2.

(Sum of subframe lengths of 1^{st} to (N+n)^{th} subframes of current frame)+(TTG length s TTG number)+(RTG length s RTG number) [Formula 3]

Formula 3 illustrates a calculating method when subframe differ in length from each other and a DL/UL ratio is N:M. Namely, the terminal is aware that a UL subframe is allocated from a next value to a value calculated from a first subframe of a UL sub-map included frame by Formula 3.

If all subframes are equal to each other in length and a DL/UL ratio is N:M, an allocation time of a UL subframe can be calculated by Formula 4.

(Subframe length s (N+n)+(TTG length s TTG number)+(RTG length s RTG number) [Formula 4]

The terminal is aware that a UL subframe is allocated from a next value to a value calculated from a first subframe of a UL sub-map included frame by Formula 4.

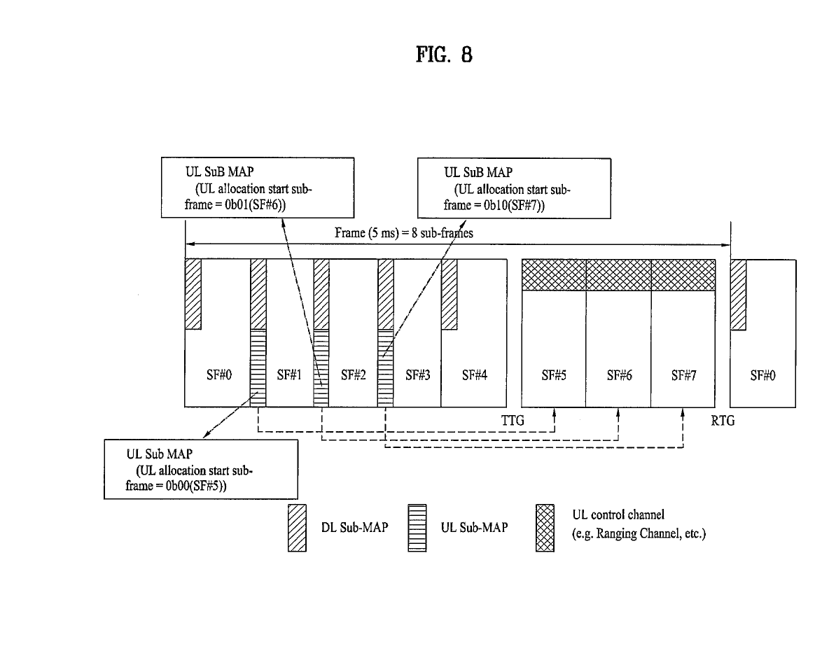

FIG. 8 is a diagram for one of methods of announcing an uplink allocation time using an uplink sub-map (UL sub-MAP) according to one embodiment of the present invention.

FIG. 8 shows a method of allocating an uplink resource if one frame is constructed with eight subframes. A DL sub-map can be included in each downlink subframe and a UL sub-map is selectively inclusive therein. In this case, a parameter indicating an allocation start time of an uplink resource can be contained in each UL sub-map. And, FIG. 8 illustrates a case of using Table 2.

The terminal receives a UL sub-map in a second subframe. In this case, UL allocation start subframe information contained in the UL sub-map is ‘0b00’. Therefore, the terminal becomes aware that an uplink resource allocation for a UL sub-map delivered in a second subframe (SF #1) starts from the beginning of a first UL subframe (SF #5). In this manner, the terminal becomes aware that an uplink resource allocation for a UL sub-map delivered in a third subframe (SF #2) starts from the beginning of a second UL subframe (SF #6). And, the terminal becomes aware that an uplink resource allocation for a UL sub-map (0b10) delivered in a fourth subframe (SF #3) starts from the beginning of a third UL subframe (SF #7).

In particular, once receiving the UL allocation start subframe information contained in the UL sub-map, the terminal becomes aware that the corresponding uplink resource is allocated to the uplink subframe in specific order. If the uplink resource is allocated to the terminal, the terminal is able to transmit data to the base station via the allocated location.

If the terminal receives a system information delivery message, it becomes aware that a ratio of DL to UL (DL/UL ratio) is 5:3 and also becomes aware that a subframe structure includes five consecutive downlink subframes and three consecutive uplink subframes. The terminal recognizes that a TTG exists in an interval for switching a downlink subframe to an uplink subframe. And, the terminal recognizes that an RTG exists in an interval for switching an uplink subframe to a downlink subframe. The base station delivers these system parameters to terminals in a manner that the system parameter values are contained in the system information delivery message (e.g., UCD or DCD). The terminals are able to calculate how many symbols are used to construct each subframe and where each subframe starts, using Formula 3 or Formula 4.

Table 3 shows a structure of UL allocation start subframe using three bits.

TABLE 3

| Name | size | Values |
|---|---|---|
| UL allocation | 3 bits | This value indicates that resource allocation |
| start sub-frame | | information indicated by a current uplink sub- |
| | | map is mapped to a prescribed uplink subframe |
| | | in specific order. |
| | | A range of this value varies according to DL/UL |
| | | ratio. |
| | | * Case that DL/UL ratio is set to 4:4 in total |
| | | 8-subframe structure: |
| | | 0b000: This indicates a first uplink frame in |
| | | UL Sub-MAP transmitted frame. |
| | | 0b001: This indicates a second uplink frame in |
| | | UL Sub-MAP transmitted frame. |
| | | 0b010: This indicates a third uplink frame in |
| | | UL Sub-MAP transmitted frame. |
| | | 0b011: This indicates a fourth uplink frame in |
| | | UL Sub-MAP transmitted frame. |
| | | 0b100~0b111: reserved |
| | | *Case that DL/UL ratio is set to 5:3 |
| | | 0b000: This indicates a first uplink frame in |
| | | UL Sub-MAP transmitted frame. |
| | | 0b001: This indicates a second uplink frame in |
| | | UL Sub-MAP transmitted frame. |
| | | 0b010: This indicates a third uplink frame in |
| | | UL Sub-MAP transmitted frame. |
| | | 0b011~0b111: reserved |
| | | *Case that DL/UL ratio is set to 6:2 |
| | | 0b000: This indicates a first uplink frame in |
| | | UL Sub-MAP transmitted frame. |
| | | 0b001: This indicates a second uplink frame in |
| | | UL Sub-MAP transmitted frame. |
| | | 0b010~0b111: reserved |

It is ale to represent UL subframe allocation information using Table 3 in case that at least four uplink subframes exist. UL allocation start subframe indicates that resource allocation indicated by a current uplink sub-map is mapped to an uplink subframe in specific order. And, a range of value possessed by the UL allocation start subframe varies according to DL/UL ratio.

In the above example, in order o reduce resource waste in the uplink sub-map, a start location of uplink allocation is announced to terminals using subframe numbers. In the following description, explained is a method of announcing resource allocation is performed after a prescribed number of frames from a start of a subframe for transmitting an uplink sub-map.

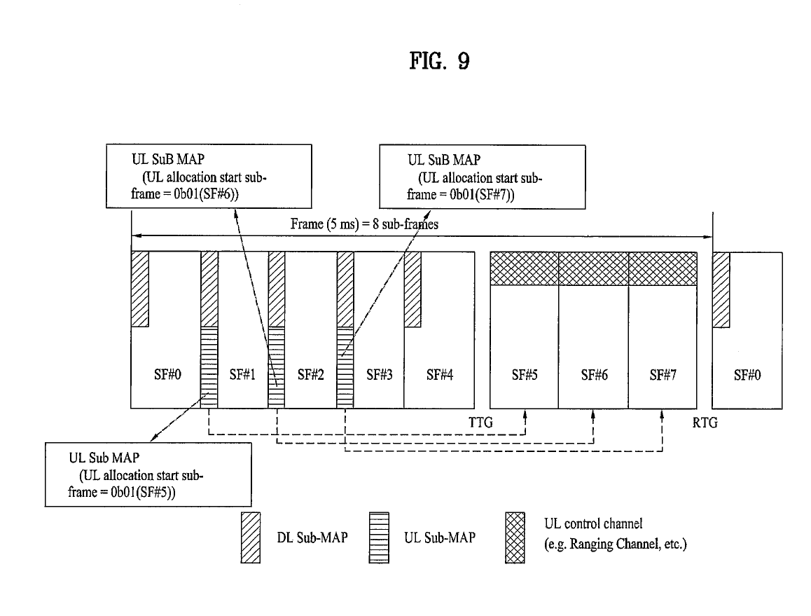

FIG. 9 is a diagram for a method of announcing an uplink allocation time using an uplink sub-map (UL Sub-MAP) according to another embodiment of the present invention.

In FIG. 9, a UL allocation time start frame contained in UL-Sub MAP is represented as Table 4.

TABLE 4

| Name | Size | Values |
|---|---|---|
| UL allocation start | 2 bits | 0b00: This value indicates two |
| sub-frame (n) | | subframes. |
| | | 0b01: This value indicates three |
| | | subframes. |
| | | 0b10: This value indicates four |
| | | subframes. |
| | | 0b11: This value indicates five |
| | | subframes. |

In Table 4, a UL allocation time start frame is constructed with two bits. The UL allocation time start frame indicates that an uplink subframe will be allocated after how many subframes from a subframe next to the subframe in which a UL sub-map is included. In this case, a minimum value indicates two subframes by considering a transmission delay. Hence, a value will be set to (2+n).

A method for a terminal to calculate an uplink allocation time using the information element shown in Table 4 is represented as Formula 5 or Formula 6.

(sum of lengths of (N+2) subframes after next subframe)+(TTG length s TTG number)+(RTG length s RTG number) [Formula 5]

Formula 5 is applicable to a case that lengths of subframes differ from each other. And, a terminal becomes aware that uplink allocation starts after a length corresponding to Formula 5 from a next frame to a subframe in which an uplink sub-map is included.

(subframe length s (N+2))+(TTG length s TTG number)+(RTG length s RTG number) [Formula 6]

Formula 6 is applicable to a case that lengths of subframes are equal to each other. And, a terminal becomes aware that uplink allocation starts after a length corresponding to Formula 6 from a next frame to a subframe in which an uplink sub-map is included.

Referring to FIG. 9, according to an uplink allocation start subframe value (0b01=3 subframes) in each sub-map, an uplink resource allocation start for an uplink sub-map delivered in SF #1 starts from the beginning of SF #5, an uplink resource allocation start for an uplink sub-map delivered in SF #2 starts from the beginning of SF #6, and an uplink resource allocation start for an uplink sub-map delivered in SF #3 starts from the beginning of SF #7.

If a terminal receives an uplink sub-map, the terminal becomes aware that an uplink resource allocation start by a sub-map starts from an uplink subframe in specific order. The terminal is able to transmit data through an allocated uplink resource. In FIG. 9, a DL/UL ratio is 5:3. Five consecutive downlink subframes come ahead of three consecutive uplink subframes.

A TTG exists in an interval for switching a downlink subframe to an uplink subframe and an RTG exists in an interval for switching an uplink subframe to a downlink subframe. Theses system parameter values are delivered by a base station to terminals via a super map or a system information delivery message (e.g., UCD or DCD). Using the obtained information, the terminal is able to calculate how many symbols construct each subframe and where each subframe starts according to Formula 5 or Formula 6.

In a system in which an allocation time for uplink is not frequently changed, if information on a UL allocation start time is transmitted each subframe, it may be waste of resources. In this case, it is able to deliver a value for an UL allocation time in a manner that the corresponding value is included in a super map or a system information delivery message (e.g., DCD, UCD).

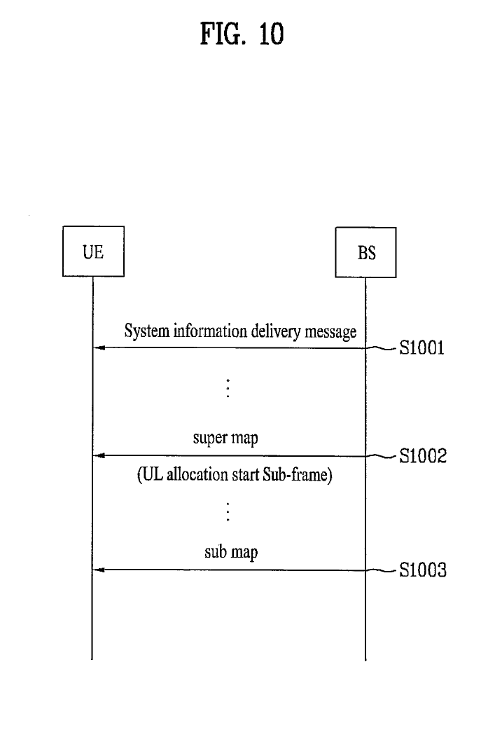

FIG. 10 is a diagram for a method of announcing an uplink allocation time using a super map according to another embodiment of the present invention.

Referring to FIG. 10, a base station transmits a system information delivery message containing base information of a system to a terminal [S1001].

The base station is able to transmit a super map, in which scheduling information on a resource region is contained, to the terminal. In doing so, the base station is able to transmit the super map in a manner that UL allocation start subframe information is contained in the super map [S1002].

Table 5 shows an example of a UL allocation start subframe information element contained in a super map.

TABLE 5

| Name | Size | Values |
|---|---|---|
| UL allocation start | 2 bits | 0b00: This value indicates two |
| sub-frame (n) | | subframes. |
| | | 0b01: This value indicates three |
| | | subframes. |
| | | 0b10: This value indicates four |
| | | subframes. |
| | | 0b11: This value indicates five |
| | | subframes. |

In Table 5, a UL allocation time start frame is constructed with two bits. The UL allocation time start frame indicates that an uplink subframe will be allocated after how many subframes from a subframe next to the subframe in which a UL sub-map is included. In this case, a minimum value indicates two subframes by considering a transmission delay. Hence, a value will be set to (2+n).

Referring now to FIG. 10, the base station transmits an uplink sub-map to the terminal [S1003].

In case of receiving the uplink sub-map, the terminal is able to be aware of an allocation location of an uplink subframe using the information of Table 5 contained in the super map. Moreover, the terminal is able to perform calculation on Formula 5 or Formula 6 using the system information delivery message and the information contained in the super map. Therefore, the terminal is able to calculate a precise uplink allocation time.

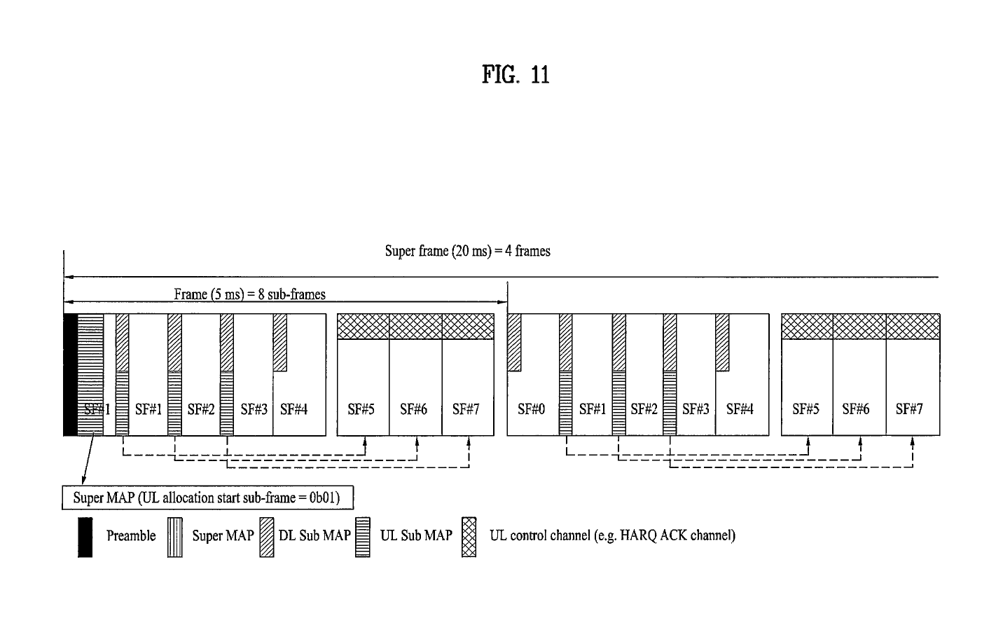

FIG. 11 is a diagram for a different method of announcing an uplink allocation time using a super map according to another embodiment of the present invention.

Referring to FIG. 11, in case of receiving an uplink allocation start subframe value (0b01=3 subframes) contained in a super map, a terminal is able to be aware of an allocation time of uplink. For instance, an uplink resource allocation start for an uplink sub-map delivered in SF #1 starts from the beginning of SF #5, an uplink resource allocation start for an uplink sub-map delivered in SF #2 starts from the beginning of SF #6, and an uplink resource allocation start for an uplink sub-map delivered in SF #3 starts from the beginning of SF #7.

A parameter carried on a super map is identically applied to all subframes within a super frame. If a terminal receives an uplink sub-map, the terminal becomes aware that an uplink resource allocation start by a sub-map starts from an uplink subframe in specific order. If an uplink resource is allocated to the terminal, the terminal is able to transmit data through the allocated uplink resource.

In FIG. 11, a DL/UL ratio is 5:3. In a subframe structure, five consecutive downlink subframes come ahead of three consecutive uplink subframes. A TTG exists in an interval for switching a downlink subframe to an uplink subframe and an RTG exists in an interval for switching an uplink subframe to a downlink subframe. Theses system parameter values are delivered by a base station to terminals via a super map or a system information delivery message (e.g., UCD or DCD). Using the system parameter values, the terminal is able to calculate how many symbols construct each subframe and where each subframe starts. For this, the terminal is able to use Formula 5 or Formula 6.

If a wireless access system supports an uplink allocation time that is intermediately changeable, the base station transmits the changed uplink allocation time information to terminals in a manner that the changed uplink allocation time information is contained in an uplink sub-map (or a sub-map). In doing so, Table 4 is available.

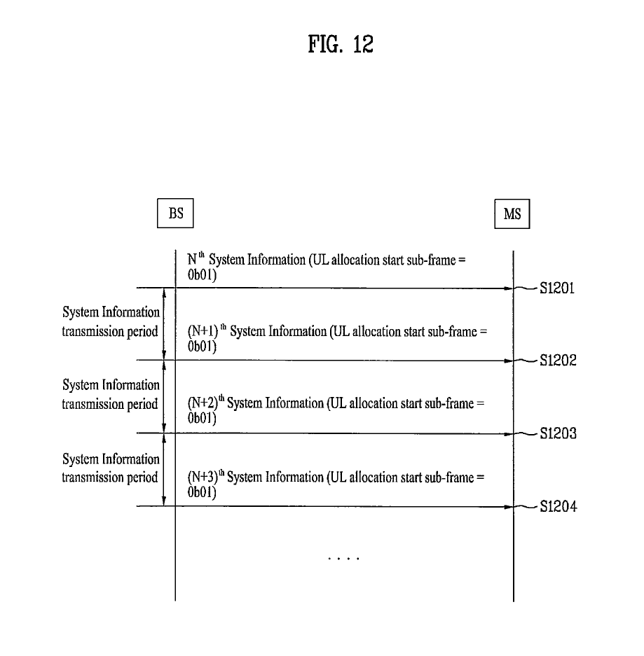

FIG. 12 is a diagram for a method of announcing an uplink allocation time using a system information delivery message according to another embodiment of the present invention.

Referring to FIG. 12, a base station is able to transmit a system information delivery message to a terminal each transmission period of system information [S1201 to S1204].

In this case, the base station is able to transmit a UL allocation start subframe information element to the terminal in a manner that UL allocation start subframe information element is contained in the system information delivery message.

Table 6 shows an example of an information element contained in a system information delivery message.

TABLE 6

| Name | Size | Values |
|---|---|---|
| UL allocation start | 2 bits | 0b00: This value indicates two |
| sub-frame (n) | | subframes. |
| | | 0b01: This value indicates three |
| | | subframes. |
| | | 0b10: This value indicates four |
| | | subframes. |
| | | 0b11: This value indicates five |
| | | subframes. |

In Table 6, a UL allocation time start frame is constructed with two bits. The UL allocation time start frame indicates that an uplink subframe will be allocated after how many subframes from a subframe next to the subframe in which a UL sub-map is included. In this case, the base station can consider a transmission delay of at least two subframes. Hence, a value of the UL allocation time start frame will be set to (2+n).

Referring now to FIG. 10, in order to deliver a system information delivery message (e.g., UCD) each period, the base station is able to transmit the uplink resource allocation start time information of the subframe unit in Table 6 in a manner that the uplink resource allocation start time information is contained in the system information delivery message. In Table 6, according to the value set in the UL allocation start subframe, the terminal is able to recognize that the uplink allocation starts behind three frames from a next frame to a subframe in which an uplink sub-map is transmitted. The precise allocation time is calculated TTG and RTG included in-between like Formula 5 or Formula 6.

If a system supports an uplink allocation time that is intermediately changeable, the base station transmits the changed uplink allocation time information to terminals in a manner that the changed uplink allocation time information, as show in Table 4, is contained in an uplink sub-map (or a sub-map).

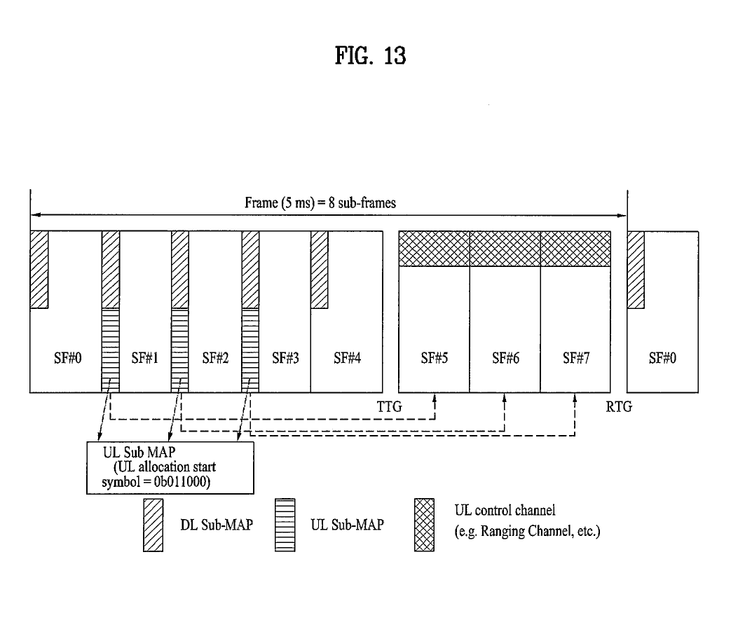

FIG. 13 is a diagram for a method of announcing an uplink allocation time by a symbol unit according to another embodiment of the present invention.

Referring to FIG. 13, a base station is able to transmit an uplink sub-map to a terminal in a prescribed subframe. In this case, the base station enables an uplink allocation start symbol information element to be contained in the uplink sub-map.

Table 7 shows an example of an information structure indicating an uplink resource allocation time of symbol unit contained in a UL sub-map.

TABLE 7

| Name | Size | Values |
|---|---|---|
| UL | 6 bits | Indicated value is the number of symbols |
| allocation | | and indicates that uplink allocation |
| start symbol | | starts after how many symbols (n^{th} symbol) |
| | | from a timing point of the beginning of a |
| | | subframe including an uplink sub-map. |

If TTG or RTG is included between a time of the beginning of a subframe and an uplink allocation time, the terminal is able to calculate a precise uplink resource allocation time by considering the TTG or RTG. Formula 7 or Formula 8 represents a method of calculating an uplink allocation time by symbol unit.

(sum of lengths of n symbols)+(TTG length s TTG number)+(RTG length s RTG number) [Formula 7]

Formula 7 is applicable to a case that symbols differ from each other in length. In particular, uplink is allocated after the symbol indicated by Formula 7 from the beginning of a subframe in which an uplink sub-map is included.

(one symbol length Sn)+(TTG length s TTG number)+(RTG length s RTG number) [Formula 8]

Formula 8 is applicable to a case that lengths of symbols are equal to each other. In particular, uplink is allocated after the symbol indicated by Formula 8 from the beginning of a subframe in which an uplink sub-map is included.

The terminal is able to obtain basic frame configuration information by receiving a system information delivery message or a super map from the base station. For instance, the terminal becomes aware that a DL/UL ratio is 5:3.

The terminal becomes aware that, in a subframe structure, five consecutive downlink subframes come ahead of three consecutive uplink subframes. The terminal becomes aware that a TTG exists in an interval for switching a downlink subframe to an uplink subframe. And, the terminal becomes aware that an RTG exists in an interval for switching an uplink subframe to a downlink subframe.

Using the obtained information, the terminal is able to calculate how many symbols construct each subframe and where each subframe starts. For this, the terminal is able to use Formula 7 or Formula 8.

Referring to FIG. 13, the terminal becomes aware of an allocation location of an uplink subframe by considering a UL allocation start symbol value and one TTG contained in the sub-map. In this case, the UL allocation start symbol value can be represented as a bitmap (e.g., 0b011000). In FIG. 13, the bitmap is a binary number and indicates the number of symbols. In particular, ‘0b011000’ indicates twenty-four symbols.

Therefore, in case of receiving the bitmap contained in the sub-map, the terminal becomes aware of an allocation location of an uplink subframe for the corresponding sub-map. Referring to FIG. 13, the terminal becomes aware of the following. First of all, an uplink resource allocation start for an uplink sub-map delivered in SF #1 starts from the beginning of SF #5, an uplink resource allocation start for an uplink sub-map delivered in SF #2 starts from the beginning of SF #6, and an uplink resource allocation start for an uplink sub-map delivered in SF #3 starts from the beginning of SF #7.

In case of receiving an uplink sub-map, the terminal becomes aware that an uplink resource allocation start by the uplink sub-map starts from an uplink subframe in specific order. If an uplink resource is allocated to the terminal, the terminal is able to transmit data to the allocated location.

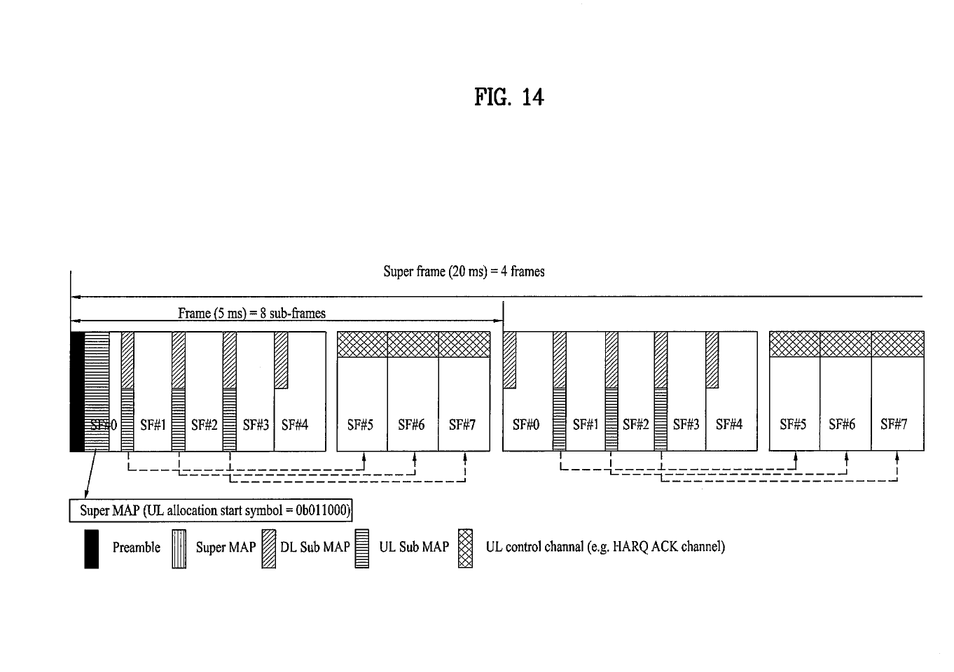

FIG. 14 is a diagram for a method of announcing an uplink allocation time by a symbol unit using a super map according to another embodiment of the present invention.

Referring to FIG. 14, a base station is able to transmit a super map to a terminal. In this case, the base station enables an uplink allocation start symbol information element to be contained in the super map. Table 8 shows an example of uplink allocation time information of symbols unit contained in a super map.

TABLE 8

| Name | Size | Values |
|---|---|---|
| UL | 6 bits | Indicated value is the number of symbols |
| allocation | | and indicates that uplink allocation |
| start symbol | | starts after how many symbols (n^{th} symbol) |
| | | from a timing point of the beginning of a |
| | | subframe including an uplink sub-map. |

If TTG or RTG is included between a time of the beginning of a subframe and an uplink allocation time, the terminal is able to calculate a precise time by considering the TTG or RTG. In particular, the terminal is able to recognize the information contained in Table 8 using Formula 7 or Formula 8.

Referring to FIG. 14, the terminal is able to recognize an allocation location time of an uplink using an uplink allocation start symbol value (e.g., 0b011000: twenty-four symbols; four subframes). For instance, the terminal becomes aware of the following. First of all, an uplink resource allocation start for an uplink sub-map delivered in SF #1 starts from the beginning of SF #5, an uplink resource allocation start for an uplink sub-map delivered in SF #2 starts from the beginning of SF #6, and an uplink resource allocation start for an uplink sub-map delivered in SF #3 starts from the beginning of SF #7.

The parameter delivered by the super map is identically applied to all subframes within a super frame. Therefore, in case of receiving an uplink super map, the terminal becomes aware that an uplink resource allocation by a sub-map starts from an uplink subframe in specific order. If an uplink resource is allocated to the terminal, the terminal is able to transmit data using the allocated resource.

If a wireless access system supports an uplink allocation time that is intermediately changeable, the base station transmits the changed uplink allocation time information to terminals in a manner that the changed uplink allocation time information is contained in an uplink sub-map (or a sub-map). Namely, if the uplink allocation time is changed, the base station is able to transmit a sub-map containing the information element described with reference to Table 7.

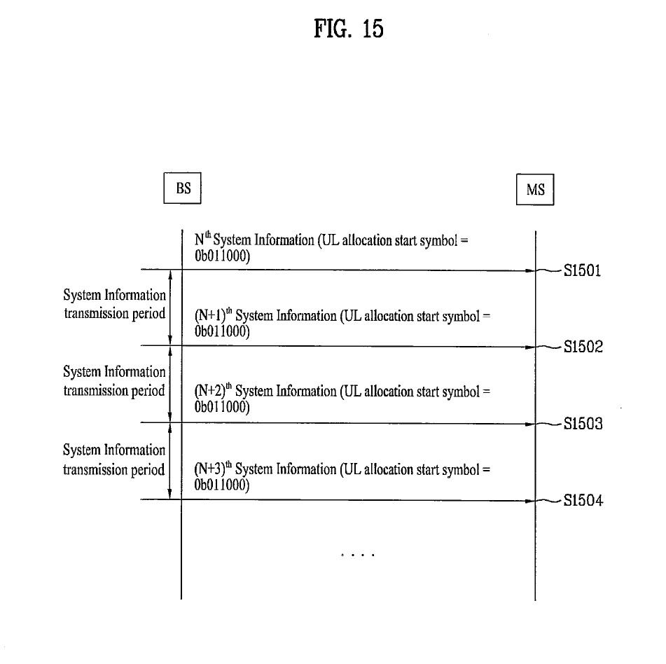

FIG. 15 is a diagram for a method of announcing an uplink allocation time by a symbol unit using a system information delivery message according to a further embodiment of the present invention.

Referring to FIG. 15, a base station is able to transmit a system information delivery message to a terminal each transmission period of system information [S1501 to S1504].

In this case, the base station is able to transmit a UL allocation start subframe information element to the terminal in a manner that UL allocation start subframe information element is contained in the system information delivery message. Table 9 shows an example of an information element contained in a system information delivery message.

TABLE 9

| Name | Size | Values |
|---|---|---|
| UL | 6 bits | Indicated value is the number of symbols |
| allocation | | and indicates that uplink allocation |
| start symbol | | starts after how many symbols (n^{th} symbol) |
| | | from a timing point of the beginning of a |
| | | subframe including an uplink sub-map. |

If TTG or RTG is included between a time of the beginning of a subframe and an uplink allocation time, the terminal is able to calculate a precise time by considering the TTG or RTG. In particular, the terminal is able to recognize the information contained in Table 8 using Formula 7 or Formula 8.

The base station is able to deliver the system information delivery message (e.g., UCD) every period. In this case, the base station is able to transmit uplink resource allocation time information of symbol unit in a manner of having the uplink resource allocation time information contained in the system information delivery message.

Referring to FIG. 15, a value set in a UL allocation start symbol included in a system information delivery message is ‘0b011000’. Therefore, the terminal becomes aware that an uplink is allocated behind twenty-four symbols from a subframe in which an uplink sub-map is transmitted. In this case, the terminal is able to use Formula 7 or Formula 8.

If a wireless access system supports an uplink allocation time that is intermediately changeable, the base station transmits the changed uplink allocation time information, as shown in Table 7, to terminals in a manner that the changed uplink allocation time information is contained in an uplink sub-map (or a sub-map).

Accordingly, the present invention provides the following effects and/or advantages.

First of all, in a frame structure supporting a subframe, the present invention provides a method of enabling a base station to deliver information on an allocation start time of an uplink resource by subframe unit or symbol unit to terminals, thereby reducing waste of resources.

Secondly, in a frame structure supporting a subframe, the present invention provides a method of enabling a terminal to calculate a precise uplink resource allocation start time using information received from a base station, thereby reducing waste of resources.

Besides, embodiments of the present invention are applicable to various wireless access systems. For example, the various wireless access systems include 3GPP (3rd Generation Partnership Project), 3GPP2 and/or IEEE 802.xx (Institute of Electrical and Electronic Engineers 802) system and the like.

Furthermore, embodiments of the present invention are applicable to all applied technical fields of the various wireless access systems as well.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of allocating a resource region, comprising the steps of:
receiving a system information delivery message including subframe configuration information;
receiving a map message including information on an allocation location of an uplink resource region; and
calculating a time of allocating the uplink resource region using the subframe configuration information and the information on the allocation location of the uplink resource region.

2. The method of claim 1, wherein the map message comprises an uplink sub-map message and wherein the information on the allocation location of the uplink resource region indicates that the resource region is allocated to a prescribed uplink subframe in specific order among uplink subframes.

3. The method of claim 1, wherein the map message comprises a super map message and wherein the information on the allocation location of the uplink resource region indicates that the resource region is allocated to a prescribed uplink subframe in specific order among uplink subframes.

4. The method of claim 1, wherein the map message comprises an uplink sub-map message and wherein the information on the allocation location of the uplink resource region indicates that an uplink resource region is allocated after a prescribed subframe in specific order from a next subframe to a subframe in which the uplink sub-map is received.

5. The method of claim 1, wherein the map message comprises a super map message and wherein the information on the allocation location of the uplink resource region indicates that an uplink resource region is allocated after a prescribed subframe in specific order from a next subframe to a subframe in which the uplink sub-map is received.

6. The method of claim 1, wherein the map message comprises an uplink sub-map message and wherein the information on the allocation location of the uplink resource region indicates that an uplink resource region is allocated after a prescribed symbol from a subframe in which the uplink sub-map is received.

7. The method of claim 1, wherein the map message comprises a super map message and wherein the information on the allocation location of the uplink resource region indicates that an uplink resource region is allocated after a prescribed symbol from a subframe in which the uplink sub-map is received.

8. The method of claim 1, further comprising the step of if the allocation location of the uplink resource region is changed, receiving an uplink sub-map including changed location information of the uplink resource region.

9. The method of claim 1, wherein the subframe configuration information includes at least one selected from the group consisting of information on a ratio of uplink to downlink (DL/UL ratio), a switching time between the uplink and the downlink, information on a TTG length, a TTG number, an RTG length and an RTG number.

10. A method of allocating a resource region, comprising the steps of:
receiving a system information delivery message including subframe configuration information and information on an allocation location of an uplink resource region; and
calculating a time of allocating the uplink resource region using the subframe configuration information and the information on the allocation location of the uplink resource region.

11. A method of allocating a resource region, comprising the steps of:
transmitting a system information delivery message including subframe configuration information;
transmitting a map message including information on an allocation location of an uplink resource region; and
receiving an uplink signal through the uplink resource region calculated according to the subframe configuration information and the information on the allocation location of the uplink resource region.

12. A method of allocating a resource region, comprising the steps of:
transmitting a system information delivery message including subframe configuration information and information on an allocation location of an uplink resource region; and
receiving an uplink signal through the uplink resource region calculated using the subframe configuration information and the information on the allocation location of the uplink resource region.
